(19) United States
(12) Patent Application Publication
(10) Pub. No.: US 2006/0017688 A1
(43) Pub. Date: Jan. 26, 2006

(54) Electro-optical display

(75) Inventors: Kai Hohmann, Babenhausen (DE); Heinrich Noll, Gross-Umstadt (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft

(21) Appl. No.: 11/185,337

(22) Filed: Jul. 20, 2005

(30) Foreign Application Priority Data
Jul. 22, 2004 (DE) 10 2004 035 668.8

(51) Int. Cl. G09G 3/36

(52) U.S. Cl. 345/102

(57) ABSTRACT

An electro-optical display includes a graphics controller and an illuminating device for illuminating a display field of the electro-optical display. A plurality of sensors record actual operating data which are delivered to a control unit and compared with setpoint operating data. If the actual operating data deviate from the setpoint operating data, the control unit performs corrective action on the display. Corrective action is performed by regulating the drive current of the illuminating device, and changing the pulse-width modulation of the illuminating device, or by modifying color values in the graphics memory of the graphics controller of the electro-optical display.

### BACKGROUND OF THE INVENTION

The invention relates to an electro-optical display having a graphics controller and having one or more light sources or organic light-emitting diodes (OLEDs), which can transmissively illuminate a display field of the electro-optical display, the electro-optical display having one or more sensors to record actual operating data which are delivered to a control unit and compared with setpoint operating data and, the control unit performing corrective action on the display if the actual operating data deviate from the setpoint operating data.

Light sources, especially light-emitting diodes of different colors as background lighting of transmissive electro-optical displays, particularly liquid-crystal displays, are distinguished by different luminous intensities and color tolerances depending on the process. According to the technology, the luminous intensity and color of individual light sources changes to a varying extent as a function of the temperature and overall operating time. In particular, the mixed color from a combination of light sources with two or more colors is subject to large color and brightness tolerances. If the light source is used for the transmissive background lighting of color displays, then all the representable colors vary. The size of the deviation depends on the spectral emission of the light sources, the spectral transmission of the color filter of the display, and the change thereof as a function of the temperature and overall operating time.

### SUMMARY OF THE INVENTION

An object of the present invention to provide an electro-optical display having one or more sensors to record actual operating data which are delivered to a control unit and compared with setpoint operating data, which can be correctively driven in a straightforward way when the actual operating data deviate from the setpoint operating data.

This object is achieved according to the invention in that the recordable operating data include the operating temperature of the light sources or organic light-emitting diodes and/or the overall operating time of the light sources and/or the drive current of the light sources or organic light-emitting diodes and/or the brightness of the light sources or organic light-emitting diodes, which are compared in the control unit with setpoint operating data stored as characteristics or setpoint values, and the corrective action is performed by regulating the drive current of the light sources or organic light-emitting diodes and/or by changing the pulse-width modulation of the light sources or organic light-emitting diodes and/or by modifying the color values in the graphics memory of the graphics controller of the electro-optical display.

This design makes it possible to maintain a constant brightness, both of the individual colors and of the resulting mixed color, as a function of temperature and the lifetime of the light sources. Technologically attributable color position drifts as a function of temperature and lifetime can be compensated for, and the color positions can be kept constant over the display field.

The actual operating data may be recorded at particular intervals during operation, for example one second, ten minutes or one minute, and/or when the operating state of the display changes.

In the case of a display installed in a motor vehicle, for example, start-up of the motor vehicle may be an operating state change of the display which initiates recording of the operating data.

The electro-optical display is preferably a liquid-crystal display, in which case the light sources may be light-emitting diodes.

To achieve color representation, the light sources may have different colors, in which case the different colors may be red and/or green and/or blue.

Corrective action on the drive current of the light sources designed as light-emitting diodes is preferably performed by regulating the forward current of the light-emitting diodes or organic light-emitting diodes.

The setpoint operating data stored as characteristics may be temperature drift characteristics and/or ageing drift characteristics. The brightness of the light sources are preferably recorded by brightness sensors on the display field.

If the brightness sensors are in this case color-selective brightness sensors, then the brightness is recorded separately for each color and can also be corrected separately.

For color selection, the brightness sensors may be provided with corresponding color filters.

The control unit is preferably a host controller.

The light sources or organic light-emitting diodes may be drivable by a driver, to which the control unit can deliver corrective drive signals.

The electro-optical display is preferably arranged in a motor vehicle, and may be the display of an on-board monitor and/or the display of a combination instrument and/or the display of a head-up display.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements out the several views:

FIG. 1 is a block diagram of a first embodiment of an electro-optical display according to the present invention; and

FIG. 2 is a block diagram of a second embodiment of an electro-optical display according to the present invention.

### DETAILED DESCRIPTION OF THE PRESENTLY PREFERRED EMBODIMENTS

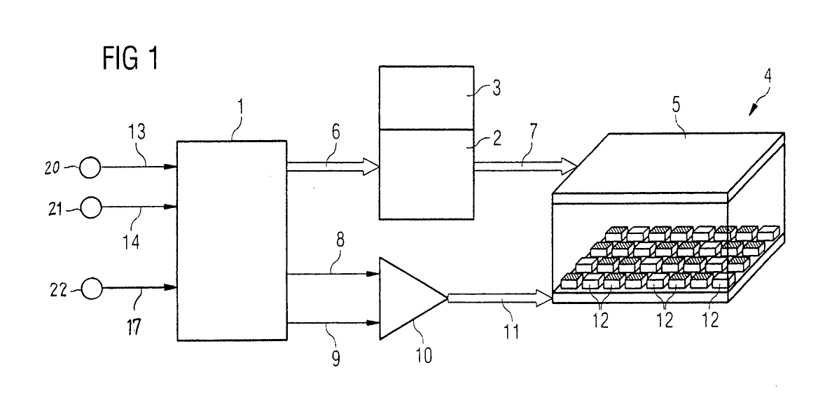

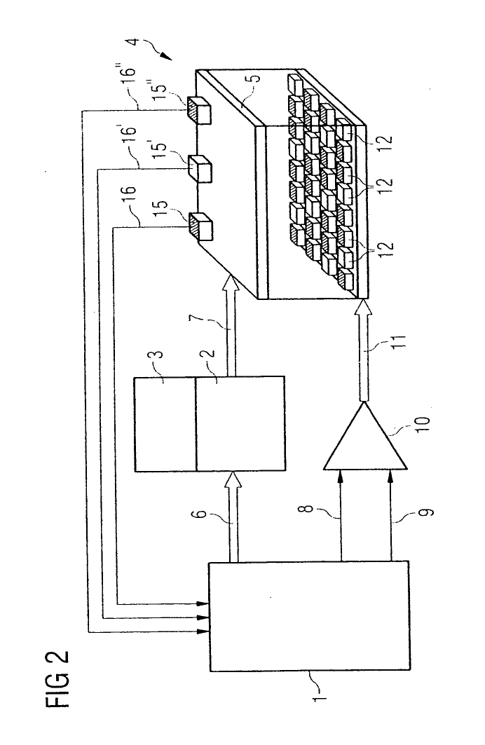

The block diagrams represented in FIGS. 1 and 2 show a host controller 1 which is connected to a drive connection 6 for driving a graphics controller 2 which has a graphics memory 3. The color values of the colors red, green and blue are stored in the graphics memory 3.

A further drive connection 7 connects the output of the graphics controller 2 to a graphical liquid-crystal display 4 having a display field for driving a graphical liquid-crystal display 4.

The host controller 1 furthermore transmits an LED current control signal over a signal line 8 and a pulse-width modulation control signal over a further signal line 9, to an LED driver 10 which drives light-emitting diodes 12 over a drive connection 11.

The light-emitting diodes 12 emit red, green or blue light and are arranged on the other side of the display field 5 from an observer (not shown), to illuminate the display field 5 transmissively.

In FIG. 1, the host controller 1 has a temperature value input 13 which receives signals corresponding to the temperature respectively recorded at the light-emitting diodes 12 from a temperature sensor 20 and delivers the signals to the host controller 1.

Signals concerning the overall operating time of the light-emitting diodes 12 are furthermore delivered to the host controller 1 by a time input 14 connected to a sensor 21 which monitors the overall or cumulative operating time that a light-emitting diode is in operation. The host controller 1 may also register the overall operating time using an internal timebase.

Signals concerning the drive current of the light-emitting diodes 12 may be delivered to the host controller 1 by lines 17 connected to a current sensor 22.

Temperature drift characteristics and ageing drift characteristics of the light-emitting diodes 12 are stored in the host controller 1 of FIG. 1.

In FIG. 2, color-selective brightness sensors 15, 15′ and 15″ arranged on the display field 5 respectively record the brightness of the colors red, green and blue and deliver corresponding signals over lines 16, 16′ and 16″ to the host controller 1.

Brightness setpoint values for the colors red, green and blue are stored in the host controller 1 of FIG. 2.

If the signals received by the host controller 1 over lines 16, 16′ and 16″ deviate from the setpoint values, the host controller 1 supplies the LED driver 10 with corresponding drive signals which are corrective values.

A correction of the LED current control signal is therefore effected by the signal line 8, which is an LED forward current control signal in FIG. 2. A correction of the pulse-width modulation control signal is effected using a signal transmitted over a control line 9. The LED driver 10 drives the light-emitting diodes 12 in accordance with these control signals.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An electro-optical display, comprising:
a graphics controller generating a display drive signal and having a graphics memory storing color values;
a display unit connected to said graphics controller by a first drive connection and receiving the display drive signal, the display unit comprising an illuminating device comprising one of at least one light source transmissively illuminating a display field and a display field including a plurality of organic light-emitting diodes;
at least one sensor for recording actual operating data of the electro-optical display, the actual operating data comprising one of an operating temperature of the illuminating device, a drive current of the illuminating device, a brightness of the illuminating device, and an overall operating time of the illuminating device; and
a control unit connected for receiving the recorded actual operating data, and comparing the actual operating data to setpoint operating data stored in said control unit, the control unit being further arranged and dimensioned for effecting a corrective action if the actual operating data deviate from the setpoint operating data by one of regulating a drive current of the illuminating device, changing a pulse-width modulation of the illuminating device, and modifying the color values in said graphics memory.

2. The electro-optical display of claim 1, wherein the control unit is arranged such that the actual operating data is recorded by the art least one sensor at one of predetermined intervals and when the operating state of the display changes.

3. The electro-optical display of claim 1, wherein the electro-optical display is a liquid-crystal display.

4. The electro-optical display of claim 1, wherein said light sources comprise light-emitting diodes.

5. The electro-optical display of claim 1, wherein said display unit comprises a plurality of said light sources, and the light sources emit different colors.

6. The electro-optical display of claim 5, wherein the different colors emitted include at least one of red, green, and blue.

7. The electro-optical display as claimed in claim 4, wherein the corrective action is effected by regulating the forward current of said light-emitting diodes or said organic light-emitting diodes.

8. The electro-optical display of claim 1, wherein the setpoint operating data comprise at least one of temperature drift characteristics and ageing drift characteristics.

9. The electro-optical display of claim 1, further comprising brightness sensors arranged on the display field recording the brightness of the illuminating device.

10. The electro-optical display of claim 9, wherein the illuminating device emits different colors and said brightness sensors are color-selective brightness sensors.

11. The electro-optical display of claim 1, wherein said control unit is a host controller.

12. The electro-optical display of claim 1, further comprising a driver for driving the illuminating device, said control unit arranged for generating corrective drive signals and transmitting the corrective drive signals for effecting the corrective action.

13. The electro-optical display of claim 1, wherein the electro-optical display is arranged in a motor vehicle.

14. The electro-optical display of claim 13, wherein the electro-optical display is the display of one of an on-board monitor, a display of a combination instrument, and a display of a head-up display.
